(19) United States
(12) Patent Application Publication
(10) Pub. No.: US 2024/0023153 A1
(43) Pub. Date: Jan. 18, 2024

(54) REDUCING POWER CONSUMPTION FOR DEVICE-TO-DEVICE COMMUNICATION

(71) Applicant: Sony Group Corporation, Tokyo (JP)

(72) Inventors: Torgny PALENIUS, Barsebäck (SE); Anders BERGGREN, Lund (SE); Nafiseh Seyed MAZLOUM, Lund (SE); Basuki PRIYANTO, Lund (SE)

(21) Appl. No.: 18/031,796

(22) PCT Filed: Oct. 15, 2021
(86) PCT No.: PCT/EP2021/078723

§ 371 Date: Apr. 13, 2023

(30) Foreign Application Priority Data
Oct. 22, 2020 (SE) 2051231-5

(51) Int. Cl. H04W 72/542; H04W 52/02; H04W 72/02

(52) U.S. Cl. CPC H04W 72/542; H04W 52/0216; H04W 72/02

(57) ABSTRACT

Methods and devices for performing device-to-device, D2D, communication in a wireless communication device. In one aspect, a method performed by the wireless communication device comprises: obtaining (301) measurement data indicative of one or more of: a spatial or temporal property of the wireless communication device, or presence of other wireless communication devices; determining (302), based on the measurement data, a configuration of resource pool, RP, monitoring for D2D communication; and performing (303) the D2D communication in accordance with the configuration of RP monitoring. The determining (302) may be made in order to adjust power efficiency of the D2D communication based on the measurement data. If the measurement data is indicative of a traffic-related risk of a user of the wireless communication device, the method will improve power efficiency of D2D communication while maintaining traffic safety.

### TECHNICAL FIELD

The present disclosure relates to the field of telecommunication and, more particularly, techniques for operating wireless communication devices to perform device-to-device (D2D) communication, for example so-called sidelink communication as defined in 3GPP.

### BACKGROUND

The 3rd Generation Partnership Project, 3GPP, is responsible for the standardization of the Universal Mobile Telecommunication System, UMTS, and Long Term Evolution, LTE. The 3GPP work on LTE is also referred to as Evolved Universal Terrestrial Access Network, E-UTRAN. LTE is a technology for realizing high-speed packet-based communication that can reach high data rates both in the downlink and in the uplink and is thought of as a next generation mobile communication system relative to UMTS. In order to support high data rates, LTE allows for a system bandwidth of 20 MHz, or up to 100 MHz when carrier aggregation is employed. LTE is also able to operate in different frequency bands and can operate in at least Frequency Division Duplex, FDD, and Time Division Duplex, TDD, modes. 3GPP is also responsible for standardization of the New Radio (NR), also referred to as a 5G radio technology. In NR the system bandwidth is flexible and similar to LTE it can operate in both FDD and TDD.

In an E-UTRAN, a User Equipment (UE) or wireless communication device is wirelessly connected to a Base Station, BS, commonly referred to as a NodeB, in UMTS, and as an evolved NodeB, eNodeB or eNB, in LTE. In NR, a base station may also be referred to as gNB. A Base Station, BS, or an access point, or a transmission and reception point (TRP) is a general term for a radio network node capable of transmitting radio signals to a UE and receiving signals transmitted by a UE.

So-called device-to-device (D2D) communication has also been standardized in 3GPP for cellular networks. D2D communication in telecommunication networks is defined as direct communication between two or more UEs without traversing the base station or core network. One of its main benefits is the low latency in communication due to a shorter signal traversal path and a minimized signaling procedure. In the context of E-UTRAN and NR, the direct link between two UEs is denoted sidelink (SL), and D2D communication is denoted sidelink communication. SL communication is, for example, specified in LTE Rel-14 and NR Rel-16.

Central to SL transmission and reception is the concept of resource pools (RP). A resource pool is a set of resources assigned to the sidelink communication and defines the resource blocks to be used by the UE when performing the sidelink communication. There are two types of RPs: Reception Resource Pools (RX RPs) and Transmission Resource Pools (TX RPs). For every TX RP there is an associated RX RP in order to enable communication. If a device transmits using a TX RP then other devices may consider that resource as an RX RP to receive the transmitted signal/channel. The RPs may be signaled by the base station via RRC signaling in a broadcast SIB12 when the UE is “in coverage” of the base station or be preconfigured for use when the UE is “out-of-coverage” of the base station.

The UE is configured to intermittently monitor the RP for detection of incoming SL transmissions. In LTE Rel-14 and NR Rel-16, the configuration of the RP is static and thereby has to be designed for the use case with the highest requirements.

One use for D2D communication is in vehicle-to-everything (V2X) communication, for example for traffic safety enhancement. V2X refers to communication between a vehicle and any entity that may affect, or may be affected by, the vehicle. This includes other vehicles, as well as so-called Vulnerable Road Users (VRUs), which include non-motorized road users such as pedestrians and cyclists. In one use case, a VRU carrying a UE is included in an SL group for traffic safety and receives information from vehicles when the VRU UE is close to traffic, for example at a crossing. If traffic is intense, the rate of the SL messages will be high. The members of the SL group that are present at this traffic situation need to share information with low latency.

In motorized vehicles such as cars or trucks, access to power for V2X communication is less of an issue. However, for battery-powered UEs such as VRU UEs carried by pedestrians and cyclists, or UEs carried by a passenger in a motorized vehicle, power consumption is a critical issue.

The prior art comprises WO2017/133446, which proposes to mitigate transmission collision or congestion in D2D communication by causing the UE to select resource based on determined resource collision and/or signal congestion. Further, with regard to V2X communication, it is proposed to assign UEs to different groups if the UE is in a lane or outside a lane, and cause the UEs in different groups to choose different resources for D2D communication. In addition, it is proposed for the UE to reduce its transmit power or refrain from transmitting, for example based on a measured speed and/or acceleration of the UE.

### SUMMARY

It is an objective to at least partly overcome one or more limitations of the prior art.

A further objective is to improve power efficiency of D2D communication in wireless communication devices.

Another objective is to improve power efficiency of D2D communication as used in V2X while maintaining traffic safety.

One or more of these objectives, as well as further objectives that may appear from the description below, are at least partly achieved by a method, for use in a wireless communication device, for performing D2D communication, a computer-readable medium, a wireless communication device, a method carried out in a base station, and a base station according to the independent claim, embodiments thereof being defined by the dependent claims.

A first aspect of the present disclosure is a method, for use in a wireless communication device, for performing device-to-device, D2D, communication, wherein the method comprises: obtaining measurement data which is indicative of one or more of: a spatial or temporal property of the wireless communication device, or presence of other wireless communication devices; determining, based on the measurement data, a configuration of resource pool monitoring for D2D communication with one or more of the other wireless communication devices, wherein the configuration of resource pool monitoring is determined in order to adjust power efficiency of the D2D communication based on the obtained measurement data; and performing the D2D communication in accordance with the configuration of resource pool monitoring.

By the first aspect, the configuration of resource pool monitoring may be adjusted in view of one or more properties of the wireless communication device and/or its environment to thereby improve the power efficiency of the wireless communication device when performing D2D communication.

A second aspect is a computer-readable medium comprising program instructions which, when executed by a processing system, cause the processing system to perform the method of the first aspect or any of its embodiments.

A third aspect is a wireless communication device comprising one or more sensor devices and logic which is configured to the perform the method of the first aspect or any of its embodiments.

A fourth aspect is a method carried out in a base station of a wireless communication network for managing device-to-device, D2D, communication between wireless communication devices, wherein the method comprises: transmitting, to at least a subset of the wireless communication devices, a set of configurations for resource pool monitoring for D2D communication between the wireless communication devices, wherein the configurations define a periodicity of the resource pool monitoring, and a size of resources that are monitored during the resource pool monitoring, and wherein the configurations differ by at least one of the periodicity or the size of the resources.

A fifth aspect is a base station comprising logic which is configured to the perform the method of the fourth aspect or any of its embodiments.

Still other objectives, aspects, and technical effects, as well as features and embodiments will appear from the following detailed description, the attached claims and the drawings.

### BRIEF DESCRIPTION OF DRAWINGS

Embodiments will now be described in more detail with reference to the accompanying schematic drawings.

FIG. 1 is an explanatory diagram of V2X communication in a cellular network.

FIG. 2 is a top plan view of a region with two intersecting roads and indicates zones of different traffic intensity.

FIG. 3A is a flowchart of an example method for performing D2D communication in a wireless communication device, and FIG. 3B is a flowchart of an example procedure for evaluating measurement data in the example method of FIG. 3A.

FIG. 4 is a block diagram of an example module for configuring resource pool monitoring.

FIG. 5 is a top plan view of a crossing and indicates example zones corresponding to different configurations of resource pool monitoring.

FIGS. 6A-6E are graphs of example configurations of resource pool monitoring.

FIG. 7 is a flow chart of an example method of configuring resource pool monitoring in a wireless communication device.

FIG. 8 is a block diagram of an example wireless communication device.

FIG. 9 is a block diagram of a wireless communication device that may implement any one of the methods, procedures and functions described herein.

### DETAILED DESCRIPTION OF EXAMPLE EMBODIMENTS

Embodiments will now be described more fully hereinafter with reference to the accompanying drawings, in which some, but not all, embodiments are shown. Indeed, the subject of the present disclosure may be embodied in many different forms and should not be construed as limited to the embodiments set forth herein; rather, these embodiments are provided so that this disclosure may satisfy applicable legal requirements. Like numbers refer to like elements throughout.

Also, it will be understood that, where possible, any of the advantages, features, functions, devices, and/or operational aspects of any of the embodiments described and/or contemplated herein may be included in any of the other embodiments described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more”, even though the phrase “one or more” or “at least one” is also used herein. As used herein, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments.

It will furthermore be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing the scope of the present disclosure. As used herein, the term “and/or” includes any and all combinations of one or more of associated listed elements.

Well-known functions or constructions may not be described in detail for brevity and/or clarity. Unless otherwise defined, all terms (including technical and scientific terms) used herein have the same meaning as commonly understood by one of ordinary skill in the art to which this disclosure belongs.

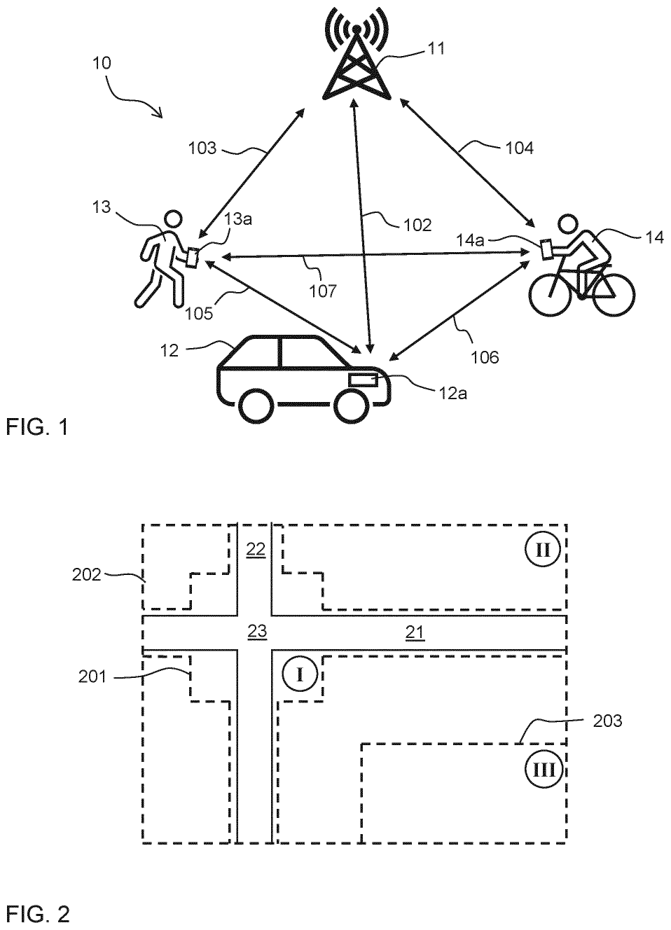

FIG. 1 provides a schematic diagram of a wireless communication system 10, which includes wireless communication devices 12a, 13a, 14a, and infrastructure equipment 11. In the following, the infrastructure equipment 11 is denoted a base station (BS), but may, for example, also be referred to as a network element or a coordinating entity and provides a wireless access interface to the one or more communication devices within a coverage area or cell. The wireless communication devices 12a, 13a, 14a may communicate data via the transmission and reception of signals representing data using the wireless access interface. The BS 11 is communicatively linked to a core network (not shown), which may be connected to one or more other communication systems or networks which have a similar structure to that in FIG. 1. The core network may also provide functionality including authentication, mobility management, charging and so on for the communications devices served by the BS 11. In the following, the respective wireless communication device 12a, 13a, 14a in FIG. 1 is denoted a user equipment (UE), but may also be referred to as a communication terminal, terminal device, and so forth, and is configured to communicate with all other UEs that are served by the same or a different coverage area via the BS 11. These communications may be performed by transmitting and receiving signals representing data using the wireless access interface over the two-way communication links represented by double-ended arrows 102, 103, 104. The system 10 may operate in accordance with any known protocol. In some examples, the system 10 may operate in accordance with the 3GPP Long Term Evolution (LTE) standard in which the BS 11 in commonly referred as evolved NodeB (eNB). In some examples, the system 10 may operate in accordance with the 3GPP New Radio (NR) standard in which the BS 11 in commonly referred as gNB.

In the system 10 of FIG. 1, the UEs 12a, 13a, 14a are also operable to perform direct device-to-device (D2D) communications with one another when they are within range of each other. D2D communications comprise UEs directly communicating data between one another without control data being communicated via a dedicated coordinating entity such as the BS 11. In FIG. 1, D2D communication links are represented by double-ended arrows 105, 106, 107.

D2D communication for cellular networks has been standardized by the 3GPP, for example in 3GPP TS 36.331, 36.300, 38.300, 38.331, and 23Series describing proximity services. In terms of the lower stack, the D2D interface is called “sidelink” (SL). Thus, the term sidelink describes the channel structure, i.e. logical channels, transport channels, and physical channels that are used in the air-interface to realize D2D communication. D2D communication has been adapted for so-called V2X (vehicle-to-everything) communication in 3GPP Release 14 and onwards, to support various traffic related use cases. V2X refers to a communication system that supports various types of communication, such as V2I (vehicle-to-infrastructure), V2N (vehicle-to-network), V2V (vehicle-to-vehicle), V2P (vehicle-to-pedestrian), V2D (vehicle-to-device) and V2G (vehicle-to-grid).

The following description will distinguish between a Vulnerable Road User (VRU) and a Non-Vulnerable Road User (NVRU). As used herein, the term VRU refers to a non-motorized road user, such as a pedestrian or a cyclist. The term NVRU refers to all road users not being a VRU. NVRUs thus include cars, trucks, lorries, buses, motorcycles, etc. In the example of FIG. 1, the pedestrian 13 and the cyclist 14 are VRUs and the vehicle 12 is an NVRU. A UE carried by a VRU is referred to as a VRU UE, and a UE that is installed in or otherwise carried by an NVRU is referred to as a NVRU UE.

A key concept in cellular D2D communication is that of a resource pool (RP) which defines the subset of available subframes and resource blocks for sidelink transmission or sidelink reception. Sidelink communication is a half-duplex scheme and a UE may be configured with multiple transmit resource pools (TX RPs) and multiple receive resource pools (RX RPs). These may be signaled by the BS for an in-coverage case or be preconfigured for an out-of-coverage case. For every TX RP, there is an associated RX RP in order to enable D2D communication. There are currently two modes of resource assignment. In Mode 1, the BS indicates the resources to be used by the UE for transmission, including the resources within an RP. In Mode 2, the UE selects an RP and the resources therein from one or more preconfigured RPs, which may be stored in the UE in manufacture or received from the BS. For Mode 1, the UE needs to be fully connected to the network (RRC CONNECTED state), whereas Mode 2 also works for UEs that are idle (RRC IDLE state) or out-of-coverage.

A UE configured for D2D communication intermittently or periodically monitors resources for detection of incoming signals intended for the UE from one or more other UEs within range. In the context of the present disclosure, this monitoring is denoted “resource pool monitoring”, abbreviated RP monitoring. In the current 3GPP standard for D2D communication, the period at which the UE is configured to listen for potential communications is a fixed value. This brings about drawbacks and limitations, which will be exemplified with reference to a V2X scenario for enhanced traffic safety.

To enhance traffic safety, messages may be exchanged by D2D communication between UEs, and the UEs may be configured to alert the respective user of potential risks for traffic related incidents based on received messages. For example, a VRU UE may receive information from NVRU UEs when the VRU UE is close to traffic, such as in crossroads, for example during rush hour but also at other times when there may be fast moving NVRUs on the same road/path as the VRU UE. Therefore, when a UE is at a crossing, the rate of the messages is high and all UEs that are members of a sidelink group for traffic safety need to be capable of transmitting to and receiving from all other UEs that are located at the crossing. Thus, all UEs that are active in the traffic situation need the same information with low latency. In these situations, the rate of messages received by the respective UE is high, and the UE needs to frequently monitor the resources, which may need to be large to support large amounts of data exchange. Given that the RP monitoring is performed at a fixed period, this means that the RP monitoring needs to be configured to account for the worst-case scenario, i.e. the highest traffic intensity and the highest vehicle speeds. This results in a high power consumption, which may be a particular problem for VRU UEs, which are typically power limited.

Reference is made to FIG. 2, which is a schematic map of a region comprising two roads 21, 22 that insect at a crossing 23. Assume that NVRUs are confined to the roads 21, 22 and VRUs are confined to dedicated paths outside of the road 21, 22, for example dedicated bicycle tracks and sidewalks, and that the VRUs and NVRUs have a respective UE (VRU UE and NVRU UE, respectively). In the example of FIG. 2, three zones 201, 202, 203, designated by I, II and III, respectively, may be defined and associated with different risk levels. Zone I extends around the crossing 23 and along the roads 21, 22 and is assigned a high risk level, zone II extends along the roads 21, 22 and is assigned a medium risk level, and zone III is located far away from the roads 21, 22 and is assigned a low risk level. For example, a VRU UE may receive messages from other UEs by D2D communication when the VRU UE is in zone I, for example during rush hour or at any other time when there may be fast moving vehicles on the roads 21, 22. All UEs that are present in zone I need to exchange messages using D2D communication at high rate and low latency. It is realized that power savings are possible, without compromising traffic safety, by configuring the VRU UEs in zone II to listen for messages at a lower rate and with lower requirement on latency. Similarly, VRU UEs in zone III may use even lower rate and latency requirement. When the VRU UE is indoors, the D2D communication for traffic safety may be disabled altogether.

The present disclosure relates to a technical modification of D2D communication to enable power savings by providing a variable monitoring scheme which allows a UE to dynamically change its RP monitoring, for example to vary or adjust power efficiency of the D2D communication based on obtained measurement data. The variable monitoring scheme may change the length of sleep periods during RP monitoring and/or the size of the monitored resources. In the following, embodiments of the variable monitoring scheme for D2D communication will be presented with reference to V2X scenarios. However, the embodiments are not limited to such scenarios but may be applied to enable power savings in any application of D2D communication.

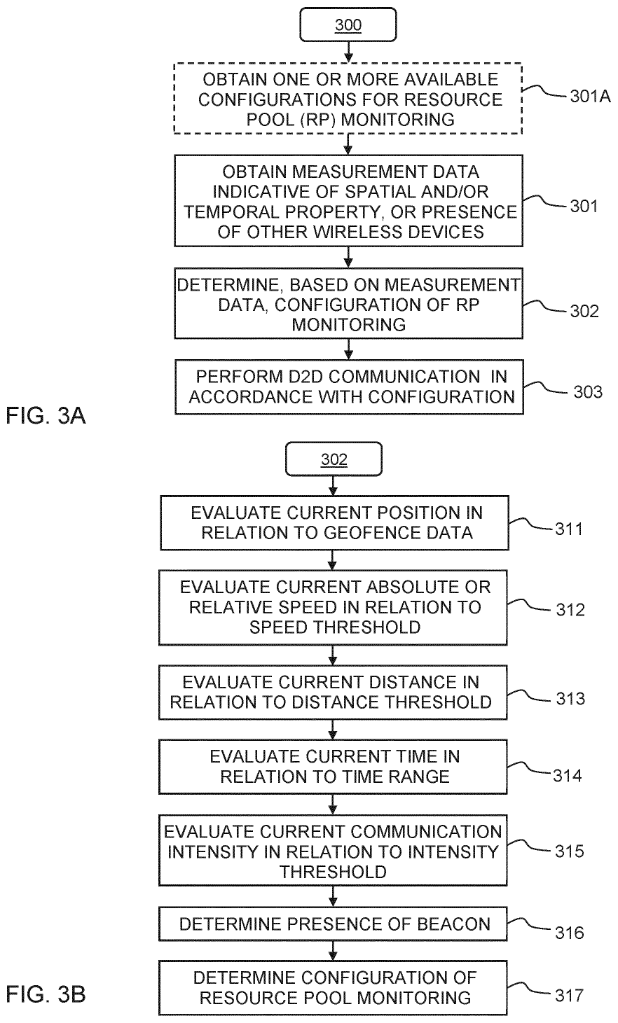

FIG. 3A is a flowchart of an example method 300, for use in a wireless communication device, for performing D2D communication. For example, the method 300 may be performed repeatedly in the wireless communication device to adjust its activity when operating in a D2D communication mode so as to reduce its power consumption. In step 301, the wireless communication device obtains measurement data which is indicative of one or more of: a spatial or temporal property of the wireless communication device, or presence of other wireless communication devices. For example, the measurement data may originate from a sensor device or other source in the wireless communication device. The measurement data represents one or more properties of the wireless communication device or its environment, in a broad sense. Measurement data indicative of a spatial property is representative of the location of the wireless communication device and may, e.g., designate an absolute location in a coordinate system, a relative location (e.g., a distance to another device) or a change in location (e.g., an absolute or relative speed, an acceleration, a direction, etc.). Measurement data indicative of a temporal property is representative of time and may, e.g., designate a current time in any time reference system. Measurement data indicative of presence is representative of other wireless communication devices that are within range of a sensor device in the wireless communication device. Such measurement data may, e.g., designate that any or a specific of the other wireless communication devices is present within range, a count of the other wireless communication devices within range, a rate of intercepted messages from the other wireless communication devices, etc. In some embodiments, as will be exemplified further below, the measurement data is obtained to be indicative of a traffic-related risk, for example for a user of the wireless communication device in relation to other wireless communication devices that perform the D2D communication, or users of such other wireless communication devices. In step 302, the wireless communication device determines, based on the measurement data, a configuration of RP monitoring for D2D communication with one or more of the other wireless communication devices. In some embodiments, the configuration of RP monitoring is determined in order to adjust power efficiency of the D2D communication based on the obtained measurement data. The configuration of RP monitoring defines the resources to be monitored for D2D communication, as well as the monitoring schedule to be used when monitoring these resources. The resources comprise one or more resources for discontinuous reception, such as one or more RX RPs stored in the UE, or a subset of the one or more RX RPs. Typically, the resources designate one or more resource blocks. The monitoring schedule defines when the resources are to be monitored. For example, the monitoring schedule may define a periodicity or rate of monitoring or, equivalently, a duration of a sleep period between active periods when the UE is monitoring the resources. In step 303, the wireless communication device performs the D2D communication in accordance with the determined configuration of RP monitoring. Thereby, in step 303, the wireless communication device is configured to monitor specific resources in accordance with the configuration, at specific time points in accordance with the configuration. As used herein, “performing D2D communication” refers to reception and/or transmission. Hence, performing D2D communication includes one or more of D2D monitoring, D2D announcing, D2D reception and D2D transmission, or any other type of D2D communication.

In the following, the configuration of RP monitoring is referred to as “RPMON configuration” for brevity. The wireless communication device may correspond to one of the UEs discussed in the foregoing, for example a VRU UE, such as UE 13a or UE 14a in FIG. 1. By the example method 300, power-limited VRU UEs are given the ability to dynamically and autonomously, based on the measurement data, adjust their RP monitoring and thereby save power. The method 300 is not limited to VRU UEs, but may also be applied to NVRU UEs. In the example of FIG. 2, the measurement data may be indicative of the current location of the UE in relation to the zones I, II and III, and the UE may select different RPMON configurations depending on its current location. In another example, the measurement data may be indicative of the current time, and the UE may select different RPMON configurations depending on the current time in relation to one or more time ranges, for example periods of peak traffic (“rush hours”).

The RPMON configurations used by a UE may differ by monitoring periodicity and/or by size of the monitored resources, corresponding to different power efficiency of the UE when performing the D2D communication. In this context, “size” refers to the extent of the resources in the time and frequency domains, for example a number of resource blocks. Generally, an increased monitoring periodicity corresponds to a lower latency, and a reduced size corresponds to a lower monitoring opportunity in terms of the number of other UEs that may be detected. For example, the size of the resources may be set to only include a specific type of UE, for example all VRU UEs but not NVRU UEs, only VRU UEs associated with pedestrians, or only VRU UEs associated with cyclists. In the following, “capacity” of a RPMON configuration refers to a combination of the monitoring periodicity and the size of the monitored resources. Thus, the capacity may be decreased by decreasing at least one of periodicity or size.

In some embodiments, the UE may store separate RX RPs for NVRUs and VRUs. To enable a VRU UE to monitor only messages from other VRU UEs, the VRU UE may store a RPMON configuration that sets the monitored resources to the RX RP for VRUs. To enable the VRU UE to monitor messages from all UEs, the VRU UE may store a RPMON configuration that sets the monitored resources to the RX RPs for VRUs and NVRUs. NVRUs may be configured to monitor the RX RPs for NVRUs and VRUs.

In some embodiments, the RX RP for VRUs is a subset of the RX RP for NVRUs. To enable a VRU UE to monitor only messages from other VRU UEs, the VRU UE may store a RPMON configuration that sets the monitored resources to the subset of the RX RP for NVRUs. To enable the VRU UE to monitor messages from all UEs, the VRU UE may store a RPMON configuration that sets the monitored resources to the entire RX RP for NVRUs. NVRUs may be configured to monitor the entire RX RP.

It should be understood that the UEs also store one or more TX RPs, which are to be used for transmission. The monitored resources of the respective RPMON configuration in a UE are defined to at least cover the TX RP or a relevant part thereof so that the UE is capable of receiving messages from a relevant set of UEs.

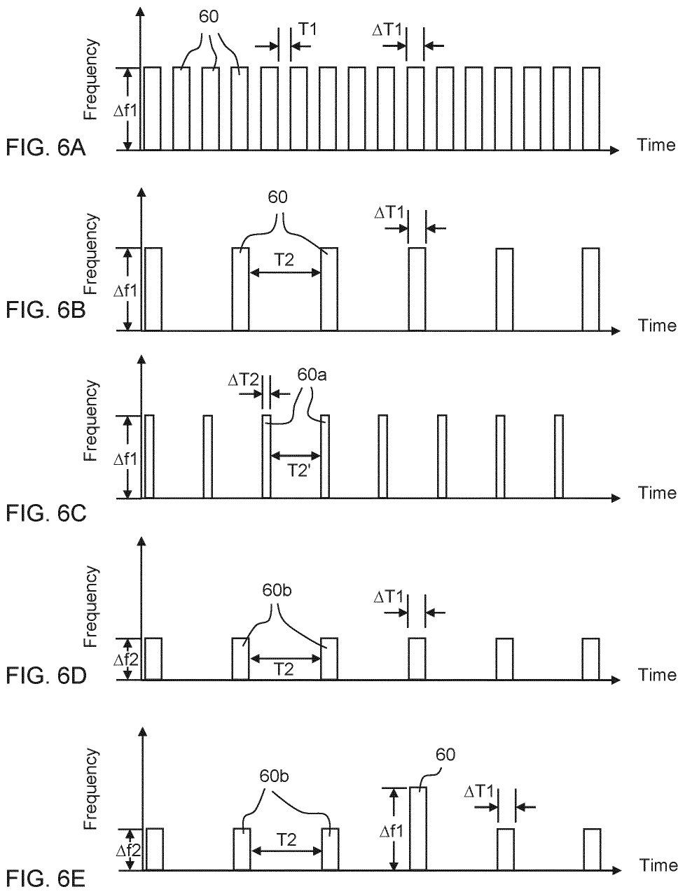

FIGS. 6A-6E show examples of RPMON configurations. FIG. 6A shows an example of an RPMON configuration of maximum capacity, in which the sleep period is T1, and the monitored resources 60 are set to ΔT1 in time and Δf1 in frequency. FIGS. 6B-6E shows examples of RPMON configurations of lower capacity compared to FIG. 6A. In FIG. 6B, the resources 60 are the same as in FIG. 6A, but the sleep period is increased to T2 (T2>T1). In FIG. 6C, the sleep period is increased to T2′ (T2′>T1), and the monitored resources 60a are decreased in the time domain to ΔT2 (ΔT2<ΔT1), while being unchanged in the frequency domain compared to FIG. 6A. In FIG. 6D, the sleep period is also increased to T2, and the monitored resources 60b are decreased in the frequency domain to Δf2 (Δf2<Δf1), while being unchanged in the time domain compared to FIG. 6A. FIG. 6E illustrates a hybrid RPMON configuration, in which the size of the monitored resources is intermittently increased, for example from a reduced size 60b to the maximum size 60 as shown, to increase the monitoring opportunities of the UE. The hybrid RPMON configuration may be used for measuring the intensity of D2D communication, as will be discussed further below with reference to step 315 in FIG. 3B.

Reverting to FIG. 3A, step 302, in some embodiments, comprises selecting the RPMON configuration among a group of available RPMON configurations stored in the wireless communication device. The available RPMON configurations may differ by at least one of the monitoring periodicity, or the size of the monitored resources. Thereby, the available RPMON configurations may result in different latency in the D2D communication, support different numbers of sidelinks, support detection of a specific type of UE, etc. In some embodiments, the UE may store a set of rules for selecting the RPMON configuration among the group of available RPMON configurations, based on the measurement data.

As understood from the foregoing, the available RPMON configurations may also depend on if the UE is in-coverage, i.e. within range of a BS, or out-of-coverage. The UE may thus store a first set of available RPMON configurations for use when in-coverage, and a second set of available RPMON configurations for use when out-of-coverage. The first set may also be used by the UE when out-of-coverage, if the UE goes from in-coverage to out-of-coverage. The first set of available RPMON configurations may be defined to monitor one or more RX RPs (or part thereof) that the UE has previously received from a BS in Mode 1, whereas the second set of available configurations may be defined to monitor one or more RX RPs (or part thereof) that are preconfigured in the UE. It is conceivable that the second set includes only one available RPMON configuration, which is thus a default configuration for use in out-of-coverage.

Thus, as indicated by dashed lines in FIG. 3A, the method 300 may comprise an optional step 301A of obtaining at least part of the available RPMON configurations and storing the at least part of the available RPMON configurations in the UE. As understood from the foregoing, the UE may receive the at least part of the available RPMON configurations by communication with a cellular network, to which the UE is connected. It should be understood that the available RPMON configurations are either preconfigured or set by the network, so that all UEs and the network are aligned and time synched.

In summary, a RPMON configuration may be obtained by the UE in accordance with any one of the following alternatives:
1) The UE receives the RPMON configuration while still maintaining the connection with the BS. The UE uses or selects the RPMON configuration once the UE goes to the idle mode and then performs the RP monitoring. In this case, the UE may be said to be preconfigured.
2) The BS conveys the RPMON configuration by broadcast via system information. Hence, the UE may receive the RPMON configuration in both connected and idle mode.
3) A combination of alternatives 1 and 2, in which limited data for the RPMON configuration is received by alternative 2, for example indicating some new parameters and/or changes for data received by alternative 1, whereas the data received by alternative 1 contains a complete RPMON configuration.
4) The UE is preconfigured to a static RPMON configuration according to specification, particularly for use in the out-of-coverage scenario.

In some embodiments, steps 301-303 are performed without communication with the cellular network. Thus, while the UE may communicate with the cellular network during steps 301-303, any such network communication is unrelated to the RP monitoring and resulting D2D communication by the UE. Stated differently, the UE determines and applies the RPMON configuration for D2D communication based solely on the measurement data, and other data stored in the UE such as the available RPMON configurations and the set of rules for selection among the available RPMON configurations based on the measurement data.

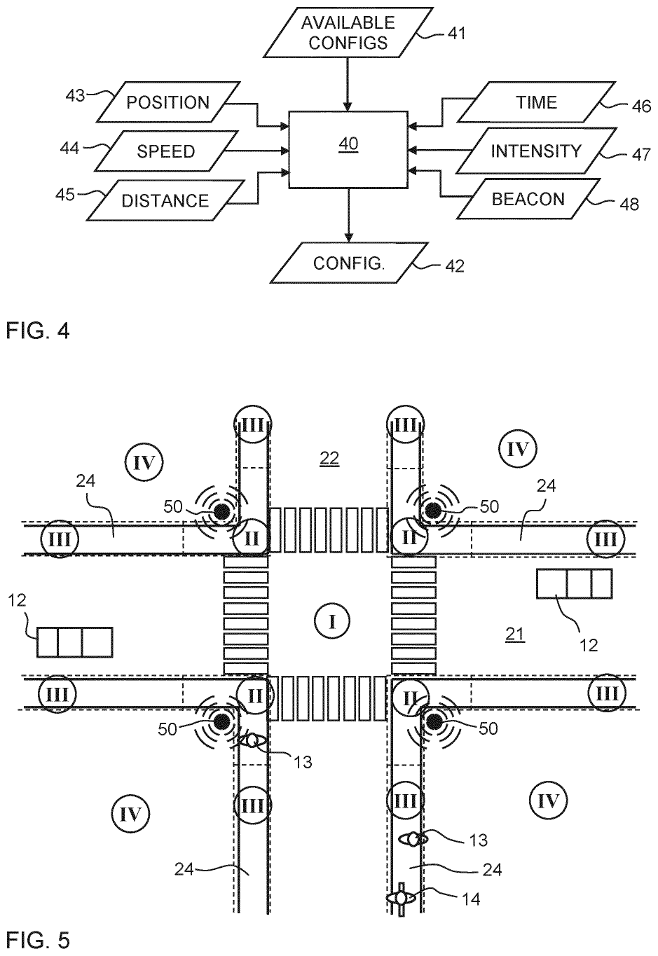

FIG. 4 is a functional block diagram showing examples of input data and output data in relation to a module 40 for determining the RPMON configuration in a UE, for example in accordance with steps 301-302 in FIG. 3A. The input data comprises the available RPMON configurations 41, and the output data is a selected RPMON configuration 42, which is then used by the UE to perform the D2D communication, for example in accordance with step 303. FIG. 4 also illustrates the above-mentioned measurement data in the form of spatial, temporal and presence parameters for the UE. Any such spatial parameter may be included in the group comprising a current position 43 of the UE, a current speed (absolute or relative) 44 of the UE, or a current distance between the UE and another UE. The temporal parameter may be a current time 46 in the UE. The presence parameter may be a current intensity 47 of communication by other UEs, or presence 48 of a beacon signal, which may be detected by the UE. It should be understood that the measurement data may include any combination of these and other parameters.

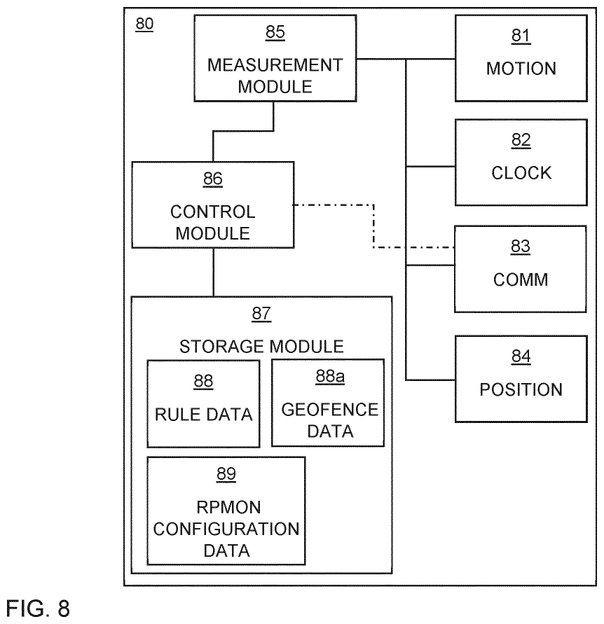

The different examples of measurement data and its use by the UE will be further exemplified with reference to FIG. 3B, which is a flow chart of an example procedure that corresponds to step 302 in FIG. 3A. The procedure 302 comprises a step 317 of determining the RPMON configuration in the UE based on the outcome of one or more preceding steps 311-316. It is important to note that steps 311-316 are given for the purpose of illustration and that the procedure 302 need not perform all of steps 311-316 but may include any subset of the steps 311-316. In all examples, it is presumed that the measurement data is determined by the UE itself, for example by use of one or more sources in the UE. Examples of sources are given below with reference to FIG. 8.

Step 311 may be performed if the measurement data comprises a current position of the UE (43 in FIG. 4). In step 311, the UE evaluates the current position in relation to one or more geofences stored in the UE. Correspondingly, step 317 determines the RPMON configuration based at least partly on the outcome of step 311.

The current position may be given in any global or local coordinate system that enables the current position to be mapped onto the geofence(s), which may be defined to correspond to coherent geographical regions. For example, the current position may be given in a Global Navigation Satellite System (GNSS), such as by latitude and longitude. Reverting to the example of FIG. 2, the geofences stored in the UE may correspond to the zones I, II and III and be associated with different RPMON configurations. Thereby, the UE may set its RPMON configuration in correspondence with its location within zones I-III, for example as discussed above, to achieve power savings without compromising traffic safety.

Step 312 may be performed if the measurement data comprises a current speed of the UE (44 in FIG. 4). In step 312, the UE evaluates the current speed in relation to one or more speed thresholds stored in the UE. Correspondingly, step 317 determines the RPMON configuration based at least partly on the outcome of step 312.

The current speed may be an absolute speed of the UE, for example in the above-mentioned global or local coordinate system, or a relative speed of the UE in relation to another UE. Such a relative speed may represent the maximum relative speed if relative speeds are measured in relation to more than one other UE. The RPMON configuration may be set in dependence of the current absolute speed to account for the type of UE. For example, NVRUs may travel at higher speeds than VRUs. If a pedestrian or a cyclist brings its UE into an NVRU, it may be undesirable for the UE to perform D2D communication with other UEs for traffic safety enhancement, which might rapidly drain the power resources of the UE. Thus, in one embodiment, step 317 may disable RP monitoring if the current absolute speed of a VRU UE exceeds a speed threshold. The relative speed may be indicative of the traffic risks in the surroundings of the UE. For example, a high relative speed may indicate the need for low latency. Thus, in some embodiments, step 317 may selectively increase the monitoring periodicity if the current relative speed exceeds a speed threshold.

Step 313 may be performed if the measurement data comprises a current distance of the UE in relation to another UE (45 in FIG. 4). The current distance may represent the minimum distance if distances are measured in relation to more than one other UE. In step 313, the UE evaluates the current distance in relation to one or more distance thresholds stored in the UE. Correspondingly, step 317 determines the RPMON configuration based at least partly on the outcome of step 313.

The current distance may be indicative of the traffic risks in the surroundings of the UE. Thus, in some embodiments, step 317 may selectively decrease the monitoring periodicity if the current relative distance exceeds a first distance threshold. Conversely, step 317 may selectively increase the monitoring periodicity if the current relative distance is below a second distance threshold.

The current distance may be given in any distance-related unit. Thus, the current distance need not be given as a physical distance, for example in meters, but may be given as a signal strength or the like.

Step 314 may be performed if the measurement data comprises a current time (46 in FIG. 4). In step 314, the UE evaluates the current time in relation to one or more time ranges stored in the UE. Correspondingly, step 317 determines the RPMON configuration based at least partly on the outcome of step 314.

The current time may be an absolute or relative time in any time unit that enables the current time to be mapped onto one or more time ranges, which may be defined to correspond to a subset of a calendar item such as a day or a week. For example, the time range may correspond to a period of peak traffic, such as at during one or more hours in the morning or evening, or at a specific day, or a period of non-peak traffic. Thus, in one embodiment, step 317 may selectively increase or decrease the monitoring periodicity and/or the size of the monitored resources if the current time falls within such a time range.

Step 315 may be performed if the measurement data comprises a parameter value indicative of the current intensity of communication by other UEs (47 in FIG. 4). In step 315, the UE evaluates the current intensity in relation to one or more intensity thresholds stored in the UE. Correspondingly, step 317 determines the RPMON configuration based at least partly on the outcome of step 315.

The current intensity of communication may represent D2D communication, or communication on another type of communication channel, to indicate presence of other UEs. The current intensity may be given in terms of the number of other UEs that are within range of the UE and/or the rate of messages intercepted by the UE, optionally for a specific type of UE, such as NVRUs. The rationale for measuring the current intensity of communication is to estimate the traffic intensity at the location of the UE. In one embodiment, step 317 may selectively increase the monitoring periodicity and/or the size of the monitored resources if the current intensity of communication exceeds an intensity threshold. The current intensity of D2D communication may be measured by use of the hybrid RPMON configuration in FIG. 6E, where the current intensity is determined based on the RP monitoring for the maximum size 60 of resources. By intermittently increasing the monitored resources, the measured intensity may better reflect the actual environment of the UE. For example, resources 60b may be limited to VRUs, whereas resources 60 may include both VRUs and NRVUs.

In step 316, the UE determines if a dedicated beacon signal is present. Correspondingly, step 317 determines the RPMON configuration based at least partly on the outcome of step 316. The beacon signal may be a short-range signal (“beacon”) generated by a transmitting device (“beacon device”), which may be stationary and arranged to indicate a specific traffic situation. For example, the beacon may be a discovery signal. In one example, the beacon device may be positioned at a crossing and/or a high speed road. In one embodiment, step 317 may selectively increase the monitoring periodicity and/or the size of the monitored resources if step 316 determines presence of the beacon. In another embodiment, step 316 may be performed to supplement the outcome of any one of steps 311-315. For example, step 317 may determine a specific change of the RPMON configuration, as indicated by the outcome of one more of steps 311-315, only if step 316 also detects presence of the beacon.

The use of the measurement data as presented in FIG. 3B will be further exemplified with reference to FIG. 5, which is a top plan view of a crossing between two roads 21, 22. FIG. 5 indicates the location of two cars 12, two pedestrians 13 and one cyclist 14. Although not shown, it is assumed that the cars 12, pedestrians 13 and cyclist 14 carries a respective UE (cf. 12a, 13a, 14a in FIG. 1). Dedicated pathways 24 for cyclists and pedestrians extend along the roads 21, 22 and are connected by zebra crossings on the roads 21, 22. In FIG. 5, dashed lines indicate zones I-IV. Zone I corresponds to the roads 21, 22 and their intersection. Zone II corresponds to portions of the pathways 24 adjacent to the intersection. Zone III corresponds to portions of the pathways 24 farther away from the intersection. Zone IV corresponds to regions located on an opposing side of the pathways 24 relative to the roads 21, 22. In the example of FIG. 5, beacon devices 50 are arranged to generate beacons for receipt by UEs that are located within Zone II.

In some embodiments, the VRU UEs are arranged to perform the method 300 of FIG. 3A, with step 302 comprising steps 311 and 317. The respective VRU UE may store geofences corresponding to Zones I-IV. The geofence for Zone I may be associated with a first RPMON configuration with maximum capacity. In Zone I, the number of NVRUs may be high, and the NVRUs may move at high speed, so D2D communication needs to be performed with low latency and support a large number of messages. Zone II should be free of NVRUs, but the VRUs are close to the crossing and are likely to enter into Zone I. Thus, the geofence for Zone II may be associated with a second RPMON configuration with a capacity below the maximum capacity, in terms of periodicity and/or size. Zone III should also be free of NVRUs, and the VRUs are less likely to enter into Zone I. Thus, the geofence for Zone III may be associated with a third RPMON configuration with a smaller capacity than the second RPMON configuration. However, the capacity of the third RPMON configuration should be sufficient to signal traffic risks between pedestrians and cyclists, which both use the pathway 24. In areas with only pedestrians, for example in Zone IV, RP monitoring may be switched off and there is thus no RPMON configuration.

In some embodiments, step 302 comprises steps 311, 313 and 317. For example, to mitigate a potential lack of accuracy of the current positions, the RPMON configuration in a UE may be determined based on a combination of its current position and its current distance to NVRUs. Thus, even if the current position indicates that the UE is located in, for example, Zone III, step 317 may select an RPMON configuration of higher capacity than the third RPMON configuration if the current distance is below a distance threshold. For example, it may be difficult to determine if the cyclist 14 in FIG. 5 is on the pathway 24 or on the road 22. Thus, it may happen that a cyclist on the road is deemed to be in Zone III. By accounting for the relative distance to NVRU UEs, which is smaller on the road 22 compared to the pathway 24, the RPMON configuration may be set to better reflect the actual traffic risk. A combined use of current position and current distance may also serve to dynamically increase the RP monitoring capacity of a UE that approaches the limits of a zone, for example by a pedestrian or cyclist moving close to the road on the pathway 24 in Zone III.

In some embodiments, step 302 comprises steps 311, 314 and 317. For example, Zone I may be associated with the first RPMON configuration during peak hours, and with a fourth RPMON configuration outside peak hours (off-peak hours), the fourth RPMON configuration having a significantly lower capacity than the first RPMON configuration. A corresponding time-based adjustment of RPMON configuration may be made for Zones II and III.

In some embodiments, step 302 comprises steps 311, 315 and 317. Thus, the RPMON configuration in a UE may be determined based on a combination of its current position and the current intensity of communication. For example, even if the current position indicates that the UE is located in, for example, Zone III, step 317 may select an RPMON configuration of higher capacity than the third RPMON configuration if the current intensity is above an intensity threshold. In another example, even if the RP monitoring capacity of a UE has been decreased during off-peak hours, the UE may selectively and temporarily increase the RP monitoring capacity if the current intensity exceeds an intensity threshold.

In some embodiments, step 302 comprises steps 311, 316 and 317. For example, the presence of the beacon may cause the UE to select a specific RPMON configuration, irrespective of the current position. This may be a safety feature that ensures that the RP monitoring has a sufficient capacity, for example close to a crossing (cf. beacon devices 50 in FIG. 5). In another example, the presence of the beacon may cause the UE to selectively increase the capacity of RP monitoring in a sub-area of a zone, the sub-area being defined by the range of the beacon.

Step 302 need not include step 311. In some embodiments, step 302 comprises steps 315 and 317. For example, the RPMON configuration in a UE may be set to achieve different capacities depending on the current intensity, irrespective of the current position. In some embodiments, step 302 comprises steps 315, 316 and 317. For example, the RPMON configuration may be set to achieve a specific capacity, for example the maximum capacity, whenever the current intensity exceeds an intensity threshold or presence of the beacon is detected.

The foregoing embodiments of step 302 are merely given as examples and should not be construed as limiting. Within the context of the present disclosure, the RPMON configuration may be determined by step 302 based on, singly or in any combination, the current position, the current speed, the current distance, the current time, the current intensity, and the presence of the beacon.

To further describe the control and use of the variable RPMON configuration in a UE, a few additional examples will be given. In a first example, the UE uses V2X for traffic safety and is carried by a pedestrian. The UE is configured with three different V2P RPMON configurations with different monitoring periodicities (low, medium, high) and a corresponding map defining areas or zones where the respective RPMON configuration is valid and areas or zones where V2X is not used at all. When the pedestrian walks out from home in the morning, V2X is not used. When walking on a path to the bus, the low monitoring periodicity is used. When walking out close to the street, with vehicles being close to the UE, the monitoring periodicity is increased to medium to be aware of the vehicles in time. On the way to the bus stop, the pedestrian crosses the street, and the monitoring periodicity is set to the high periodicity. When the pedestrian enters the bus stop, the monitoring periodicity is set back to the low monitoring periodicity. In a second example, the pedestrian follows that same path late at night when traffic normally is sparse, the monitoring periodicity may be decreased in the respective area, from high to medium or low, and from medium to low. In a third example, when the pedestrian walks along a road, the UE detects that there are more and/or faster vehicles (for example, based on relative speed and/or intensity of communication) in the area, causing the UE to set the monitoring periodicity higher than normal for this area.

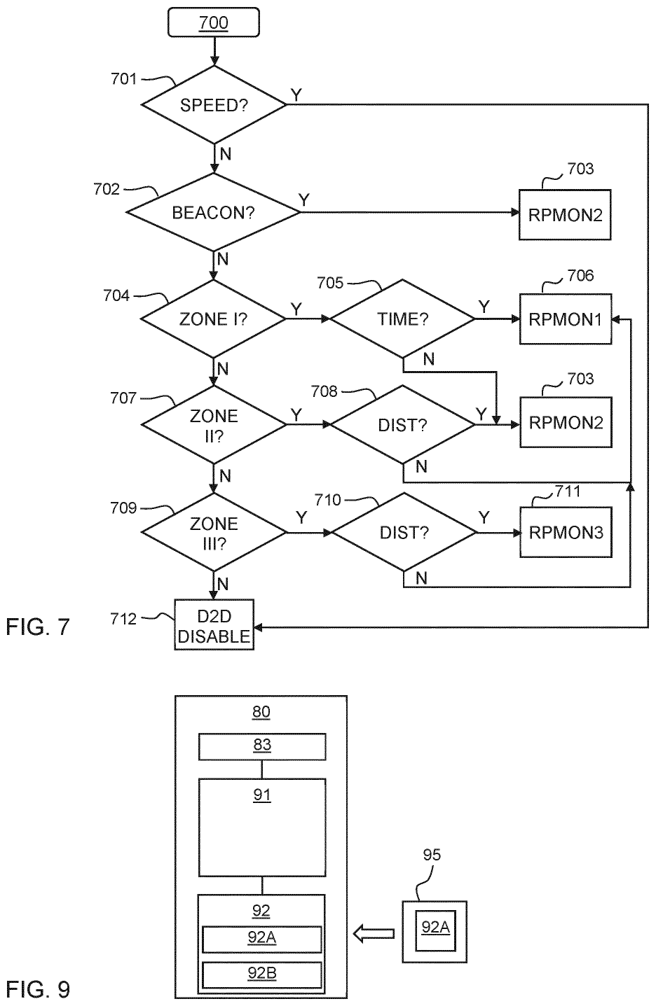

FIG. 7 is a flow chart of an example method 700 that implements a variable RP monitoring scheme in the context of FIG. 5. The method 700 may be repeatedly performed by a VRU UE and presumes that the UE repeatedly measures the current absolute speed, the current position, the current time, and the current distance to other

UEs, and repeatedly detects if the beacon is present. The method also presumes that the UE stores three RPMON configurations of high, medium and low capacity: RPMON1, RPMON2 and RPMON3. The configurations differ at least by monitoring periodicity. Step 701 is an implementation of step 312 (FIG. 3B) and evaluates the current absolute speed in relation to a speed threshold, which may set to be larger than the maximum speed for VRUs. If the current absolute speed exceeds that speed threshold, the VRU UEs is likely to be positioned in a NVRU, and the method proceeds to step 712, which disables the D2D communication. Otherwise, the method proceeds to step 702, which is an implementation of step 316 (FIG. 3B) and evaluates presence of the beacon. If the beacon is present, the method proceeds to step 703, which sets the RPMON configuration to RPMON2. This means that the VRU UE is operated at medium capacity irrespective of what zone it seems to be located in based on the current position. Otherwise, the method proceeds to step 704, which is an implementation of step 311 (FIG. 3B) and determines if the current position is within Zone I. If so, step 705 determines if the current time is within a peak hour time range. If so, the method proceeds to step 706, which sets the RPMON configuration to RPMON1. Otherwise, the method proceeds to step 703, which sets the RPMON configuration to RPMON2.

Steps 701-702 are thus implemented as override functions, which are performed irrespective of the current position. Such override functions may operate on any other parameter than position. Another example of an override function may evaluate the current relative speed and/or the current distance, for example for detection of a VRU UE or NVRU UE that is approaching rapidly, and increase the capacity of the RPMON configuration or select a specific RPMON configuration, for example RPMON1, if such a rapid approach is detected. Alternatively or additionally, a corresponding function for detecting rapid approach and setting the RPMON configuration accordingly may be performed depending on the current position, for example when the UE is located in a specific zone, for example Zone I in FIG. 5.

Steps 704-705 correspond to step 311 identifying, based on a current position included in the measurement data, a geofence associated with a first RPMON configuration (RPMON1), and step 317 setting the RPMON configuration to a second RPMON configuration (RPMON2) if a current time included in the measurement data is outside a time range stored in the UE (as determined by step 314), the second RPMON configuration defining a less frequent RP monitoring and/or a smaller set of resources than the first RPMON configuration. Thereby, power savings are attained without compromising traffic safety, since the RPMON configuration is adjusted in correspondence with the expected traffic intensity.

If the current position is not within Zone I, step 704 proceeds to step 707 which determines if the current position is within Zone II. If so, step 708 determines if the current distance is above a distance threshold. If so, the method proceeds to step 703, which sets the RPMON configuration to RPMON2. Otherwise, the method proceeds to step 706, which sets the RPMON configuration to RPMON1.

Steps 707-708 correspond to step 311 identifying, based on a current position included in the measurement data, a geofence associated with a second RPMON configuration (RPMON2), and step 317 setting the RPMON configuration to a first RPMON configuration (RPMON1) if a current distance included in the measurement data is below a distance threshold stored in the UE (as determined by step 313), the first RPMON configuration defining a more frequent resource pool monitoring and/or a larger set of resources than the second configuration. Thereby, an enhanced traffic safety is achieved without incurring excessive power consumption in the UE, since the power consumption is only increased when actually warranted for a UE located in Zone II, as indicated by the current distance in this example. A similar advantage may be attained by replacing or supplementing the current distance by the current intensity.

If the current position is not within Zone II, step 707 proceeds to step 709 which determines if the current position is within Zone III. If so, step 710 determines if the current distance is above a distance threshold. If so, the method proceeds to step 711, which sets the RPMON configuration to RPMON3. Otherwise, the method proceeds to step 706, which sets the RPMON configuration to RPMON1. Thus, in correspondence with Zone II, the power consumption is only increased when actually warranted for a UE located in Zone III.

If the current position is not within Zone III, the UE is deemed to be located in Zone IV and step 709 proceeds to step 712, which disables D2D monitoring.

In all embodiments described herein, any one of the thresholds (speed, distance, intensity) and/or the time range may be given as a function of one or more of the spatial, temporal or presence parameters. For example, a threshold or the time range may differ depending on the current position, for example between different zones.

FIG. 8 is a block diagram of an example wireless communication device 80 which may implement any of the methods, procedures and functions described herein. The term “wireless communication device” herein refers to any type of communication device capable of communicating with a wireless communication network, for example, a mobile terminal, a wireless terminal, a mobile phone, a smartphone, a computer with wireless capability, such as a laptop, a Personal Digital Assistant (PDA) or a tablet computer, an MTC UE, a UE capable of machine to machine communication, Laptop Embedded Equipment (LEE), Laptop Mounted Equipment (LME), USB dongles, or any other unit capable to communicate over a radio link in a wireless communication network. The device 80 comprises a set of sources or sensor devices, including a motion sensor 81, a clock 82, a wireless communication system 83, and a positioning system 84. A measurement module 85 is arranged to receive output data from the sensor devices 81-84 and generate the above-mentioned measurement data. The motion sensor 81 generates output data indicative of the current absolute speed of the device 80. In one example, the motion sensor 81 comprises an inertial measurement unit (IMU). The clock 82 generates output data indicative of the current time and may be configured to maintain time by use of an oscillator and/or by synchronization with an external source. The wireless communication system 83 is configured for wireless communication with a cellular network and for D2D communication. The wireless communication system 83 may be further configured for other types wireless communication, such as WiFi, Bluetooth, etc. The wireless communication system 83 is considered a sensor device to the extent that it generates output data indicative of the current intensity, the presence of the beacon, the current distance to other UEs, or the current relative speed. It may be noted that such output data may be obtained in the wireless communication system 83 by D2D communication and/or any other type of wireless communication. Measurement data indicative of current distance may be obtained by any available technique, for example based on propagation delay and/or signal strength. Similarly, measurement data indicative of current relative speed may be obtained by comparing distances measured at different time points. The positioning system 84 generates output data indicative of the current position and may include any technique for geospatial positioning, such as a GNSS receiver configured in accordance with any standard such as GPS, GLONASS, BDS, etc, or network-based geolocation, or server-supported positioning such as assisted-GPS.

The device 80 comprises a control module 86, which is configured to control the device 80 to perform at least the D2D communication as described herein. For example, the control module 86 may be configured to perform the example method 300 of FIG. 3A, or any of the other methods described herein. As indicated by a dot-dashed line, the control module 86 is configured to provide control data to the wireless communication system 83, which is thereby controlled to perform D2D communication in accordance with a RPMON configuration determined by the control module 86. The device 80 further comprises a storage module 87, which is configured to store rule data 88 which defines a set of rules for determining the RPMON configuration based on the measurement data. The rule data 88 thus defines the steps, ranges, thresholds, etc, that are used in determining the RPMON configuration. The storage module 87 may be further configured to store geofence data 88a, which defines geofence(s) that may be used for determining the RPMON configuration, as exemplified hereinabove. The storage module 87 is further configured to store RPMON configuration data, which may define available RPMON configurations.

The structures and methods disclosed herein may be implemented by hardware or a combination of software and hardware. In some embodiments, the hardware comprises one or more software-controlled computer resources. FIG. 9 schematically depicts a wireless communication device 80, which comprises a processing system 91, computer memory 92, and the above-mentioned wireless communication system 83. Although not shown, the device 80 may include any of the other sensor devices in FIG. 8. The processing system 91 may include one or more of a CPU (“Central Processing Unit”), a DSP (“Digital Signal Processor”), a GPU (“Graphics Processing Unit”), a microprocessor, a microcontroller, an ASIC (“Application-Specific Integrated Circuit”), a combination of discrete analog and/or digital components, or some other programmable logical device, such as an FPGA (“Field Programmable Gate Array”). The computer memory 92 may correspond to or include the storage module 87 in FIG. 8. A control program 92A comprising computer instructions is stored in the memory 92 and executed by the processing system 91 to implement logic that performs any of the methods, procedures, functions or steps described in the foregoing. The control program 92A may be supplied to the device 80 on a computer-readable medium 95, which may be a tangible (non-transitory) product (e.g. magnetic medium, optical disk, read-only memory, flash memory, etc.) or a propagating signal. As indicated in FIG. 9, the memory 92 may also store control data 92B for use by the processing system 91, such as rule data 88, geofence data 88a, or RPMON configuration data 89 (FIG. 8), etc.

With reference to FIG. 1 and step 301A in FIG. 3A, it is realized that the base station 11 may be configured to provide at least part of the RPMON configurations to all or a subset of the wireless communication devices in the wireless communication network. The base station 11 may thus perform a method for enabling device-to-device, D2D, communication between wireless communication devices. In some embodiments, the method comprises: transmitting, to at least a subset of the wireless communication devices, a set of configurations for RP monitoring for D2D communication between the wireless communication devices, with the configurations defining a periodicity of the RP monitoring, and a size of resources that are monitored during the RP monitoring, wherein the configurations differ by at least one of the periodicity or the size of the resources. The base station 11 may be implemented in a structure corresponding to the structure shown in FIG. 9.

While the subject of the present disclosure has been described in connection with what is presently considered to be the most practical embodiments, it is to be understood that the subject of the present disclosure is not to be limited to the disclosed embodiments, but on the contrary, is intended to cover various modifications and equivalent arrangements included within the spirit and the scope of the appended claims.

Further, while operations are depicted in the drawings in a particular order, this should not be understood as requiring that such operations be performed in the particular order shown or in sequential order, or that all illustrated operations be performed, to achieve desirable results.

In the following, clauses are recited to summarize some aspects and embodiments as disclosed in the foregoing.

C1. A method, for use in a wireless communication device (80), for performing device-to-device, D2D, communication, said method comprising:
obtaining (301) measurement data which is indicative of one or more of: a spatial or temporal property of the wireless communication device, or presence of other wireless communication devices;
determining (302), based on the measurement data, a configuration of resource pool monitoring for D2D communication with one or more of the other wireless communication devices, wherein the configuration of resource pool monitoring is determined in order to adjust power efficiency of the D2D communication based on the obtained measurement data; and
performing (303) the D2D communication in accordance with the determined configuration of resource pool monitoring.

C2. The method of C1, wherein the measurement data is obtained to be indicative of a traffic-related risk of a user of the wireless communication device (80).

C3. The method of C2, wherein the traffic-related risk is in relation to other wireless communication devices that perform the D2D communication.

C4. The method of any preceding clause, wherein the configuration of resource pool monitoring is determined such that a periodicity of the resource pool monitoring and/or a size of resources (60, 60a, 60b) that are monitored during the resource pool monitoring is adjusted based on the measurement data.

C5. The method of C4, wherein said determining (302) comprises: selecting the configuration among a group of available configurations of resource pool monitoring stored in the wireless communication device (80).

C6. The method of C5, wherein the available configurations in said group differ by at least one of the periodicity of the resource pool monitoring, or the size of the resources (60, 60a, 60b).

C7. The method of C5 or C6, further comprising: obtaining (301A) at least part of the available configurations and storing said at least part of the available configurations in the wireless communication device (80).

C8. The method of C7, wherein the wireless communication device (80) and the other wireless communication devices are configured for communication with a cellular network, wherein the method comprises receiving said at least part of the available configurations by the wireless communication device (80) by communication with the cellular network.

C9. The method of C8, wherein said obtaining (301) measurement data, said determining (302) the configuration of resource pool monitoring, and said performing (303) the D2D communication are performed without communication with the cellular network.

C10. The method of any preceding clause, wherein the measurement data indicative of the spatial property comprises one or more of: a current position (43) of the wireless communication device (80), a current speed (44) of the wireless communication device (80), or a current distance (45) of the wireless communication device (80) to at least one of the other wireless communication devices.

C11. The method of C10, wherein said determining (302) the configuration of resource pool monitoring comprises: evaluating (311) the current position in relation to one or more geofences (88a) stored in the wireless communication device (80), and determining (317) the configuration based on said evaluating (311) the current position.

C12. The method of C10 or C11, wherein said determining (302) the configuration of resource pool monitoring comprises: evaluating (312) the current speed in relation to one or more speed thresholds stored in the wireless communication device (80), and determining (317) the configuration based on said evaluating (312) the current speed.

C13. The method of C12, further comprising: disabling (712) the resource pool monitoring if the current speed (44) exceeds a speed threshold among the one or more speed thresholds.

C14. The method of any one of C10-C13, wherein said determining (302) the configuration of resource pool monitoring comprises: evaluating (313) the current distance in relation to one or more distance thresholds stored in the wireless communication device (80), and determining (317) the configuration based on said evaluating (313) the current distance of the wireless communication device (80) to said at least one of the other wireless communication devices.

C15. The method of any preceding clause, wherein the measurement data indicative of the temporal property comprises a current time (46).

C16. The method of C15, wherein said determining (302) the configuration of resource pool monitoring comprises: evaluating (314) the current time in relation to one or more time ranges stored in the wireless communication device (80), and determining (317) the configuration based on said evaluating (314) the current time.

C17. The method of any preceding clause, wherein the measurement data indicative of the presence of other wireless communication devices comprises a current intensity (47) of communication by the other wireless communication devices.

C18. The method of C17, wherein said determining (302) the configuration of resource pool monitoring comprises: evaluating (315) the current intensity in relation to one or more intensity thresholds stored in the wireless communication device (80), and determining (317) the configuration based on said evaluating (315) the current intensity.

C19. The method of any preceding clause, wherein said determining (302) the configuration of resource pool monitoring comprises: determining (317) the configuration based on detected presence (48) of a beacon signal.

C20. The method of C11, wherein said evaluating (311) the current position identifies a geofence associated with a second configuration, and wherein said determining (317) the configuration sets the configuration to a first configuration if a current distance included in the measurement data is below a distance threshold stored in the wireless communication device, the first configuration defining a more frequent resource pool monitoring and/or a larger set of resources than the second configuration.

C21. The method of C11, wherein said evaluating (311) the current position identifies a geofence associated with a first configuration, and wherein said determining (317) the configuration sets the configuration to a second configuration if a current time included in the measurement data is outside a time range stored in the wireless communication device, the second configuration defining a less frequent resource pool monitoring and/or a smaller set of resources than the first configuration.

C22. The method of any one of C4-C9, wherein the resources comprise resources used for discontinuous reception.

C23. The method of any preceding clause, wherein the wireless communication device (80) is associated with a vulnerable road user (13, 14), VRU, and said one or more of the other wireless communication devices are associated with a respective non-25 VRU (13, 14) or a respective non-vulnerable road user (12), NVRU.

C24. The method of any preceding clause, wherein the measurement data is obtained from one or more sources (81-84) in the wireless communication device (80).

C25. The method of C8 or C9, wherein the cellular network is based on a 3GPP standard, such as Long Term Evolution (LTE) or New Radio (NR).

C26. The method of any preceding clause, wherein the D2D communication comprises a 3GPP sidelink transmission.

C27. A wireless communication device comprising one or more sensor devices (81-84) and logic (91) which is configured to the perform the method of any preceding clause.

C28. A method carried out in a base station (11) of a wireless communication network for enabling device-to-device, D2D, communication (105, 106, 107) between wireless communication devices (12a, 13a, 14a), said method comprising:
transmitting, to at least a subset of the wireless communication devices (12a, 13a, 14a), a set of configurations for resource pool monitoring for D2D communication between the wireless communication devices (12a, 13a, 14a), wherein the configurations define a periodicity of the resource pool monitoring, and a size of resources that are monitored during the resource pool monitoring, and wherein the configurations differ by at least one of the periodicity or the size of the resources.

C29. A base station comprising logic (91) which is configured to the perform the method of C28.

C30. A computer-readable medium comprising program instructions (92A) which, when executed by a processing system (91), cause the processing system (91) to perform the method of any one of C1-C26 or C28.

1. A method, for use in a wireless communication device, for performing device-to-device (D2D) communication, said method comprising: obtaining measurement data which is indicative of one or more of: a spatial or temporal property of the wireless communication device, or presence of other wireless communication devices; determining, based on the measurement data, a configuration of resource pool monitoring for D2D communication with one or more of the other wireless communication devices, wherein the configuration of resource pool monitoring is determined in order to adjust power efficiency of the D2D communication based on the obtained measurement data; and performing the D2D communication in accordance with the determined configuration of resource pool monitoring.

2. The method of claim 1, wherein the measurement data is obtained to be indicative of a traffic-related risk of a user of the wireless communication device.

3. The method of claim 2, wherein the traffic-related risk is in relation to other wireless communication devices that perform the D2D communication.

4. The method of claim 1, wherein the configuration of resource pool monitoring is determined such that a periodicity of the resource pool monitoring and/or a size of resources that are monitored during the resource pool monitoring is adjusted based on the measurement data.

5. The method of claim 4, wherein said determining comprises: selecting the configuration among a group of available configurations of resource pool monitoring stored in the wireless communication device.

6. The method of claim 5, wherein the available configurations in said group differ by at least one of a periodicity of the resource pool monitoring, or a size of resources.

7. The method of claim 4, further comprising: obtaining at least part of the available configurations and storing said at least part of the available configurations in the wireless communication device.

8. The method of claim 7, wherein the wireless communication device and the other wireless communication devices are configured for communication with a cellular network, wherein the method comprises receiving said at least part of the available configurations by the wireless communication device by communication with the cellular network.

9. The method of claim 8, wherein said obtaining measurement data, said determining the configuration of resource pool monitoring, and said performing the D2D communication are performed without communication with the cellular network.

10. The method of claim 1, wherein the measurement data indicative of the spatial property comprises one or more of: a current position of the wireless communication device, a current speed of the wireless communication device, or a current distance of the wireless communication device to at least one of the other wireless communication devices.

11. The method of claim 10, wherein said determining the configuration of resource pool monitoring comprises: evaluating the current position in relation to one or more geofences stored in the wireless communication device, and determining the configuration based on said evaluating the current position.

12. The method of claim 10, wherein said determining the configuration of resource pool monitoring comprises: evaluating the current speed in relation to one or more speed thresholds stored in the wireless communication device, and determining the configuration based on said evaluating the current speed.

13. The method of claim 12, further comprising:
disabling the resource pool monitoring if the current speed exceeds a speed threshold among the one or more speed thresholds.

14. The method of claim 10, wherein said determining the configuration of resource pool monitoring comprises: evaluating the current distance in relation to one or more distance thresholds stored in the wireless communication device, and determining the configuration based on said evaluating the current distance of the wireless communication device to said at least one of the other wireless communication devices.

15. The method of claim 1, wherein the measurement data indicative of the temporal property comprises a current time.

16. The method of claim 15, wherein said determining the configuration of resource pool monitoring comprises: evaluating the current time in relation to one or more time ranges stored in the wireless communication device, and determining the configuration based on said evaluating the current time.

17. The method of claim 1, wherein the measurement data indicative of the presence of other wireless communication devices comprises a current intensity of communication by the other wireless communication devices.

18. The method of claim 17, wherein said determining the configuration of resource pool monitoring comprises: evaluating the current intensity in relation to one or more intensity thresholds stored in the wireless communication device, and determining the configuration based on said evaluating the current intensity.

19. The method of claim 1, wherein said determining the configuration of resource pool monitoring comprises: determining the configuration based on detected presence of a beacon signal.

20-27. (canceled)

28. A method carried out in a base station of a wireless communication network for enabling device-to-device communication between wireless communication devices, said method comprising: transmitting, to at least a subset of the wireless communication devices, a set of configurations for resource pool monitoring for D2D communication between the wireless communication devices, wherein the configurations define a periodicity of the resource pool monitoring, and a size of resources that are monitored during the resource pool monitoring, and wherein the configurations differ by at least one of the periodicity or the size of the resources.

29-30. (canceled)
